(19) United States
(12) Patent Application Publication
(10) Pub. No.: US 2007/0223448 A1
(43) Pub. Date: Sep. 27, 2007

(54) Routing apparatus and method

(75) Inventor: Nobuyuki Tanazawa, Shizuoka (JP)

Correspondence Address: Paul J. Esatto, Jr.;Scully, Scott, Murphy & Presser, P.C., Suite 300, 400 Garden City Plaza, Garden City, NY, 11530, US

(73) Assignee: NEC Access Technica, Ltd., Shizuoka (JP)

(21) Appl. No.: 11/726,251

(22) Filed: Mar. 21, 2007

(30) Foreign Application Priority Data
Mar. 27, 2006 (JP) 84452/2006

(51) Int. Cl. H04L 12/28

(52) U.S. Cl. 370/351

(57) ABSTRACT

A routing apparatus includes a hardware routing process section, a validating section, a control section, and a holding buffer. The hardware routing process section performs a hardware routing process on a received frame to create a transmission frame, and which then holds the created transmission frame in a transmitting buffer. The validating section executes a validating process, including a frame length check, for determining the validity of the received frame concurrently with the hardware routing process. The control section determines whether or not to transmit the transmission frame held in the transmitting buffer, in accordance with the result of the validating process. The holding buffer holds the received frame in a state before the execution of the hardware routing process.

### BACKGROUND OF THE INVENTION

1. Field of the Invention

The present invention relates to a routing apparatus and a method for routing received frames.

2. Description of the Related Art

Networking at higher speeds and larger capacities raises an increasingly important issue of speeding up a routing process, and therefore various speeding-up techniques have been proposed.

Japanese Patent Application Laid-Open Publication No. Hei 9-102790, for example, discloses a receiver-side network interface, which is designed to execute a frame receiving process of writing a received frame into a memory, concurrently with a process of performing protocol analysis on the received frame. By employing this parallel processing, the interface can therefore reduce the time required to transfer the received frame.

With increasing speed of the routing process, there has recently been a growing demand to improve the reliability of a transmission frame transmitted by a routing apparatus. However, the interface mentioned above is designed without any consideration for the improvement in the reliability of the transmission frame.

Japanese Patent Application Laid-Open Publication No. Hei 10-51480 discloses a gateway device, which is designed to execute a validating process of determining the validity of a received frame concurrently with a process of determining the transfer destination of the received frame. When it is determined in the validating process that the received frame is one not supported by the gateway device, or that a header value of the received frame is invalid, the gateway device discards the received frame. The gateway device can therefore improve the reliability of the transmission frame data by eliminating the occurrence of an abnormal frame being transmitted externally to the gateway device.

However, it cannot be safely said that checking a header portion alone for validity is sufficient to determine the validity of a received frame. The reason is that the validity in terms of a frame length and the like may not be determined until the entire frame is received. It cannot be therefore accepted that the reliability of the transmission frame transmitted by the gateway device mentioned above is sufficiently high.

When it is determined in the validating process that the received frame is one not supported by the gateway device or that a header of the received frame is without validity, the gateway device discards the received frame. For this reason, the gateway device cannot analyze the received frame having an error encountered therein. The gateway device cannot therefore diagnose the fundamental cause of the occurrence of the error, and cannot consequently improve the quality of the transmission frame.

### SUMMARY OF THE INVENTION

The present invention has been made to solve the above-mentioned problems. An exemplary feature of the present invention is to provide a routing apparatus and method capable of achieving both a high-speed routing process and a high quality of the transmitted frame.

In a first aspect of the present invention, a routing apparatus includes a hardware routing process section which performs a hardware routing process on a received frame to create a transmission frame, and which then holds the created transmission frame in a transmitting buffer, a validating section which executes a validating process, including a frame length check, for determining the validity of the received frame concurrently with the hardware routing process, a control section which determines whether or not to transmit the transmission frame held in the transmitting buffer, in accordance with the result of the validating process, and a holding buffer which holds the received frame in a state before the execution of the hardware routing process.

In a second aspect of the present invention, a routing method using a hardware routing process section includes the steps of performing, by the hardware routing process section, a hardware routing process on a received frame to create a transmission frame, and holding the created transmission frame in a transmitting buffer, executing a validating process including a frame length check for determining the validity of the received frame concurrently with the hardware routing process, holding in a holding buffer the received frame as being in a state before the execution of the hardware routing process, and determining whether or not to transmit the transmission frame held in the transmitting buffer, in accordance with the result of the validating process.

According to the present invention, the hardware routing process and the validating process are executed in parallel with each other. The hardware routing process is completed before it finishes receiving the entire frame. Thus, the routing apparatus of the present invention can transmit the transmission frame held in the transmitting buffer, as soon as the validating section recognizes the validity of the received frame. In short, the present invention can execute the routing process at high speed.

The routing apparatus of the present invention, when determining the validity of a received frame, is further adapted not only for a check of the header portion, but also for such a check where the routing apparatus cannot judge the validity until the entire frame to be received, such as the frame length. Thus, the routing apparatus does not transmit transmission frame without validity, specifically a transmission frame having a frame length error or a checksum error encountered therein. In short, the quality of the frame transmitted from this routing apparatus is extremely high.

The routing apparatus of the present invention includes the holding buffer which holds the received frame in a state before the execution of the hardware routing process. Thus, the received frame is not lost even when the validity of the received frame is denied as a result of the validating process. In other words, the routing apparatus can analyze the received frame whose validity is denied. Consequently, the routing apparatus can achieve a further improvement in the quality of the transmission frame.

### BRIEF DESCRIPTION OF THE DRAWINGS

The above and other objects, features and advantages of the present invention will become more apparent from the following detailed description when taken in conjunction with the accompanying drawings wherein:

FIG. 1 is an example of a block diagram of a routing apparatus according to an exemplary embodiment of the present invention; and

FIG. 2 is a flowchart showing an example of the operation of the routing apparatus shown in FIG. 1.

### DETAILED DESCRIPTION OF THE EXEMPLARY EMBODIMENTS

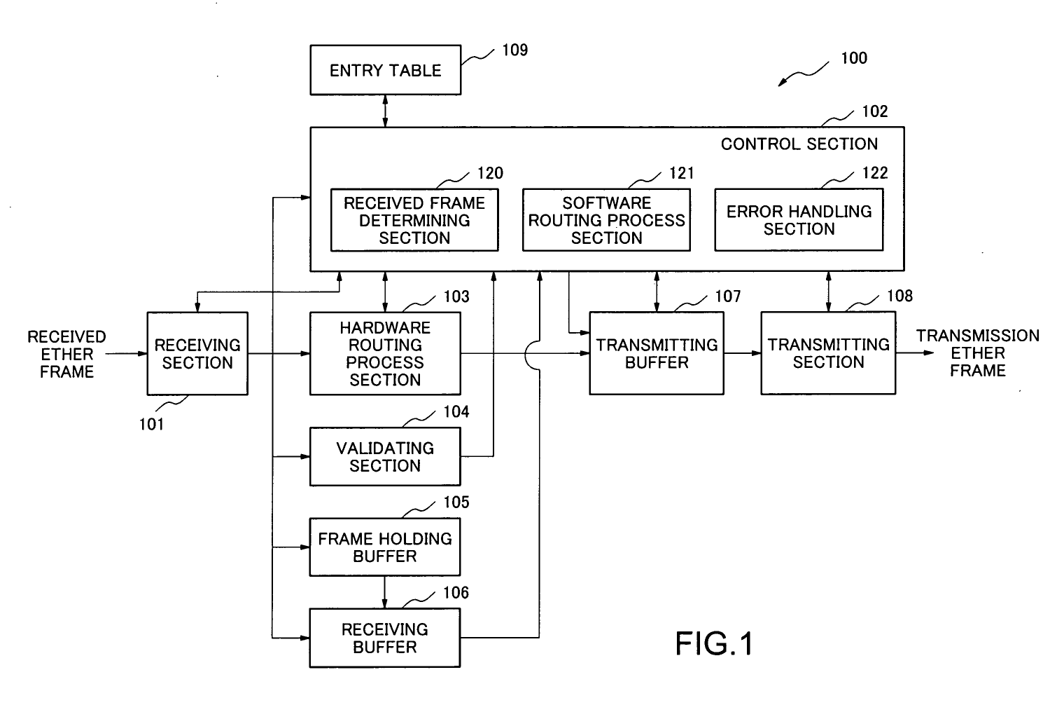

FIG. 1 is an example of a block diagram of a routing apparatus 100 according to an exemplary embodiment of the present invention. The routing apparatus 100 is basically designed to perform a routing process on a frame received from one network and transmit the frame to another network. Hereinafter is given the example in which the routing apparatus 100 performs the routing process on a frame in an Ethernet (which is a registered trade mark) format (hereinafter referred to simply as “Ether frame”) received from a LAN (local area network) and transmits the frame to a WAN (wide area network).

The routing apparatus 100 includes a receiving section 101, a control section 102, a hardware routing process section 103, a validating section 104, a frame holding buffer 105, a receiving buffer 106, a transmitting buffer 107, and a transmitting section 108.

The receiving section 101 receives an Ether frame from the LAN and transmits the received Ether frame to the control section 102, the hardware routing process section 103, the validating section 104, the frame holding buffer 105, and the receiving buffer 106.

The hardware routing process section 103 executes a hardware-based routing process on the received Ether frame to thereby create an Ether frame to be transmitted (hereinafter, referred to as “transmission Ether frame”), and holds the created transmission Ether frame in the transmitting buffer 107. The routing processes include, for example, the process of reassigning an IP (Internet Protocol) address, the process of reassigning a port number, the process of appending or removing a VLAN (virtual LAN) header, the process of appending or removing a PPPOE header, and the process of appending or removing a PPP (point-to-point protocol) header.

It is determined in the validating section 104 whether or not the frame length and checksum value of the received Ether frame are valid, and transmits the determined result to the control section 102. The frame holding buffer 105 holds the received Ether frame as being in a state before the execution of the hardware routing process. The receiving buffer 106 holds an Ether frame subject to a software routing process or an Ether frame subject to an error analysis. The transmitting buffer 107 holds the transmission Ether frame that has undergone the hardware-based or software routing process. The transmitting section 108 transmits the transmission Ether frame held in the transmitting buffer 107 to the WAN.

The control section 102 includes a received frame determining section 120, a software routing process section 121, and an error handling section 122. It is determined in the received frame determining section 120 whether or not the received Ether frame is a frame subject to the hardware routing process. A frame data entry table 109 gives definitions of the frame subject to the hardware routing process. By accessing the frame data entry table 109, it is determined in the received frame determining section 120 whether or not the received Ether frame corresponds to the frame subject to the hardware routing process. The frame subject to the hardware routing process includes IPv4 (Internet Protocol version 4)/Ether, IPv6 (Internet Protocol version 6)/Ether, IPv4/PPP/PPPoE/Ether, IPv6/PPP/PPPoE/Ether, IPv4/VLAN/Ether, IPv6/VLAN/Ether, IPv4/PPP/PPPoE/VLAN/Ether, and IPv6/PPP/PPPoE/VLAN/Ether. Information, such as a destination MAC (media access control) address, a source MAC address, a PPPOE session value, a VLAN ID, an IP protocol, a NEXT header, an IPv4 destination address, an IPv4 source address, an IPv6 destination address, an IPv6 source address, a destination port number, and a source port number, is used to determine whether or not the received Ether frame is a frame subject to the hardware routing process.

The software routing process section 121 performs the software routing process on the received Ether frame held in the receiving buffer 106.

Upon receipt of the determined result from the validating section 104, the error handling section 122 executes processing according to the determined result. Specifically, when the validity of the received Ether frame is denied, the error handling section 122 transfers to the receiving buffer 106 the received Ether frame in a state before the execution of the hardware routing process, held in the frame holding buffer 105. Then, the error handling section 122 deletes the corresponding transmission Ether frame which has undergone the hardware routing process, and which is held in the transmitting buffer 107. When the validity of the received Ether frame is recognized, the error handling section 122 transmits from the transmitting section 108 to the WAN the transmission Ether frame that has undergone the hardware routing process, held in the transmitting buffer 107.

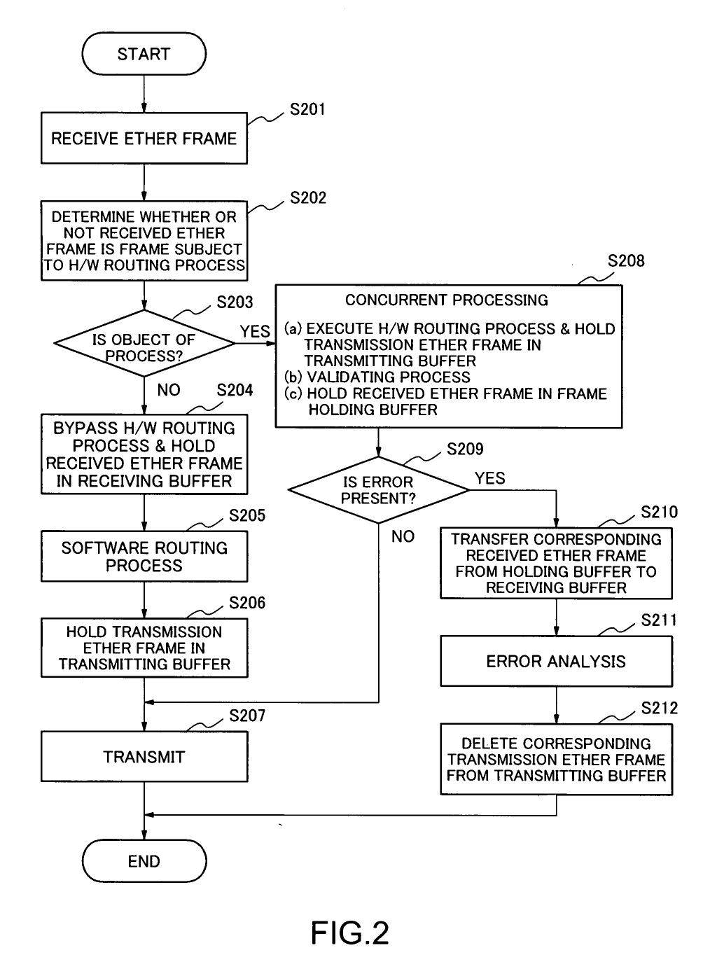

FIG. 2 is a flowchart showing an example of the operation of the routing apparatus 100 described above. The receiving section 101 receives an Ether frame from the LAN (at step S201). By referring to the frame data entry table 109, it is determined in the received frame determining section 120 of the control section 102 whether or not the received Ether frame is a frame subject to the hardware routing process (at step S202).

When the received Ether frame is not a frame subject to the hardware routing process (that is, “No” is outputted at step S203), the received Ether frame is held in the receiving buffer 106 without undergoing any processing (at step S204). The received Ether frame held in the receiving buffer 106 is subjected to the software routing process by the software routing process section 121 of the control section 102 (at step S205). The frame, after undergoing the software routing process, is held as a transmission Ether frame in the transmitting buffer 107 (at step S206). The transmission Ether frame held in the transmitting buffer 107 is transmitted to the WAN by the transmitting section 108 (at step S207).

Alternatively, when the received Ether frame is a frame subject to the hardware routing process (that is, “Yes” is outputted at step S203), the received frame determining section 120 directs the hardware routing process section 103 and the validating section 104 to start their respective processes concurrently with each other (as indicated by (a) and (b) at step S208). At this point, the received frame determining section 120 also holds the received Ether frame in the frame holding buffer 105 (as indicated by (c) at step S208). Specifically, the hardware routing process and the validating process including a frame length check are concurrently performed on the received Ether frame. In this case, the validating section 104 starts the frame length check only after the entire Ether frame is received. The hardware routing process can start, provided only that a header portion of the Ether frame, specifically data from the head of the Ether frame to the end of the port number, can be received. Thus, the hardware routing process is already finished at about the time of the completion of the validation. The result of determination made by the validating section 104 is transmitted to the error handling section 122 of the control section 102.

When the validity of the received Ether frame is denied as a result of the validation (that is, “Yes” is outputted at step S209), the error handling section 122 transfers to the receiving buffer 106 the received Ether frame in a state before the execution of the hardware routing process, held in the frame holding buffer 105 (at step S210). The error handling section 122 performs an error analysis on the received Ether-frame data in a state before the execution of the hardware routing process, held in the receiving buffer 106 (at step S211), thereby diagnosing the cause of the occurrence of an error, and the like. Then, the error handling section 122 deletes the corresponding transmission Ether frame which has undergone the hardware routing process, and which is held in the transmitting buffer 107 (at step S212).

When the validity of the received Ether frame is recognized (that is, “No” is outputted at step S209), the error handling section 122 transmits from the transmitting section 108 to the WAN the transmission Ether frame that has undergone the hardware routing process, held in the transmitting buffer 107 (at step S207).

As described above, the routing apparatus 100 according to the exemplary embodiment is configured to execute the hardware routing process and the validating process in parallel with each other. With this configuration, the routing apparatus 100 can complete the hardware routing process before it finishes receiving the entire Ether-frame. Thus, the routing apparatus 100 can transmit to the WAN the transmission Ether frame held in the transmitting buffer 107, as soon as the validating section 104 recognizes the validity of the Ether frame. In short, the routing apparatus 100 can execute the routing process at high speed.

The routing apparatus 100, when determining the validity of a received Ether frame, is further adapted not only for a check of the header portion, but also for such a check where the routing apparatus 100 cannot judge the validity until the entire frame to be received, such as the frame length. Thus, the routing apparatus 100 does not transmit transmission Ether frame without validity, specifically a transmission Ether frame having a frame length error or a checksum error encountered therein, to the WAN. In short, the quality of the Ether frame transmitted from this routing apparatus 100 is extremely high.

Incidentally, the frame length check that is one of the validations cannot be executed until the entire Ether-frame is received. Thus, the hardware routing process is already finished by the time the validation is completed, so that the received Ether frame is already converted into a transmission Ether frame. However, the received Ether frame in a state before the execution of the hardware routing process is held as it is in the frame holding buffer 105, as mentioned above. Thus, the received Ether frame is not lost even when the validity of the received Ether frame is denied as a result of the validating process. In other words, the routing apparatus 100 can analyze the received Ether frame whose validity is denied. For example, the routing apparatus 100 can determine the fundamental cause of an error, such as whether the denial of the validity is due to communication quality or malicious attacks. Consequently, the routing apparatus 100 can achieve a further improvement in the quality of the transmission Ether frame.

The routing apparatus 100 includes the received frame determining section 120 in which it is determined whether or not the received Ether frame is a frame subject to the hardware routing process, and the software routing process section 121 which executes the software routing process on the received Ether frame. This configuration enables execution of the routing process, for example even when the received Ether frame is a frame in such a format as is not supported by the hardware routing process section 103 or when a failure occurs in the hardware routing process section 103.

The above description has been given taking an instance where a received Ether frame in a state before the execution of the hardware routing process is temporarily held in the frame holding buffer 105 and thereafter transferred finally to the receiving buffer 106. However, it is to be understood that the process of saving the received Ether frame in a state before the execution of the hardware routing process is not limited to the above. For example, the received Ether frame may bypass the frame holding buffer 105 and be held directly in the receiving buffer 106. In this case, the error handling section 122 deletes the received Ether frame from the receiving buffer 106 when the validity of the received Ether frame is recognized.

Incidentally, the size of a frame can possibly become larger than its original size as a result of the routing process executed by the hardware routing process section 103. No problem arises even if the frame size enlarges, as long as the final size of the frame does not exceed the maximum length of the Ether frame. However, an error in the Ether frame will result if the final size of the frame exceeds the maximum length of the Ether frame. It is therefore desirable that a maximum length check be performed on the frame which has undergone the hardware routing process. Referring to the flowchart of FIG. 2, when the validity of the received Ether frame is recognized (that is, “No” is outputted at step S209), the transmission Ether frame corresponding to the received Ether frame is automatically transmitted to the WAN.

For example, the validating section 104 therefore performs the validation including a maximum frame length check on the transmission Ether frame in a state before being transmitted to the WAN. The result of the validation is transmitted to the error handling section 122. The error handling section 122 can delete the transmission Ether frame whose validity is denied. Alternatively, the error handling section 122 performs the software routing process on the received Ether frame in a state before the execution of the hardware routing process, corresponding to the transmission Ether frame whose validity is denied. The error handling section 122 checks that a maximum length error is absent in the frame data, and transmits the transmission Ether frame that has undergone the software routing process, to the WAN via the transmitting buffer 107 and the transmitting section 108.

As described above, the routing apparatus 100 according to the exemplary embodiment is configured to perform the validation not only on the received Ether frame in a state before the execution of the hardware routing process, but also on the transmission Ether frame which has undergone the hardware routing process. With this configuration, the routing apparatus 100 can transmit Ether frames of still higher quality.

The routing apparatus 100 described above may be applied to apparatuses in general for routing received frames, such as a router and a gateway.

While this invention has been described in connection with certain exemplary embodiments, it is to be understood that the subject matter encompassed by way of this invention is not to be limited to those specific embodiments. On the contrary, it is intended for the subject matter of the invention to include all alternatives, modifications and equivalents as can be included within the spirit and scope of the following claims.

Further, it is the inventor's intent to retain all equivalents of the claimed invention even if the claims are amended during prosecution.

What is claimed is:

1. A routing apparatus comprising:
a hardware routing process section which performs a hardware routing process on a received frame to create a transmission frame, and which then holds the created transmission frame in a transmitting buffer;
a validating section which executes a validating process, including a frame length check, for determining the validity of the received frame concurrently with the hardware routing process;
a control section which determines whether or not to transmit the transmission frame held in the transmitting buffer, in accordance with the result of the validating process; and
a holding buffer which holds the received frame in a state before the execution of the hardware routing process.

2. The routing apparatus according to claim 1, wherein when the validity of the received frame is denied in the validating process, the control section deletes the corresponding transmission frame which is held in the transmitting buffer, and which has undergone the hardware routing process.

3. The routing apparatus according to claim 1, wherein when the validity of the received frame is denied in the validating process, the control section reads, from the holding buffer, the received frame in a state before the execution of the hardware routing process, and performs an error analysis on the readout received frame.

4. The routing apparatus according to claim 1, wherein the control section comprises a received frame determining section which determines whether or not the received frame is a frame subject to the hardware routing process.

5. The routing apparatus according to claim 4, wherein the control section further comprises a software routing process section which executes a software routing process on the received frame.

6. The routing apparatus according to claim 5, wherein the software routing process section executes the software routing process on a received frame judged as not being an object of the hardware routing process by the received frame determining section.

7. The routing apparatus according to claim 5, wherein the validating section performs a validity determination, including a maximum frame length check, on the transmission frame that has undergone the hardware routing process.

8. The routing apparatus according to claim 7, wherein when the validity of a transmission frame that has undergone the hardware routing process is denied, the software routing process section executes the software routing process on the received frame corresponding to the transmission frame, and being in a state before the execution of the hardware routing process.

9. A routing method using a hardware routing process section, comprising the steps of:
performing, by the hardware routing process section, a hardware routing process on a received frame to create a transmission frame, and holding the created transmission frame in a transmitting buffer;
executing a validating process including a frame length check for determining the validity of the received frame concurrently with the hardware routing process;
holding in a holding buffer the received frame as being in a state before the execution of the hardware routing process; and
determining whether or not to transmit the transmission frame held in the transmitting buffer, in accordance with the result of the validating process.

10. The routing method according to claim 9, further comprising the step of deleting a transmission frame which has undergone the hardware routing process, and which is held in the transmitting buffer, when the validity of the corresponding received frame is denied in the validating step.

11. The routing method according to claim 9, further comprising the step of performing an error analysis, which involves reading from the holding buffer, the received frame data in a state before the execution of the hardware routing process, and performing the error analysis on the read received frame data, when the validity of the received frame data is denied in the validating step.

12. The routing method according to claim 9, further comprising the step of determining whether or not the received frame is a frame subject to the hardware routing process.

13. The routing method according to claim 12, further comprising the step of executing a software routing process on the received frame.

14. The routing method according to claim 13, wherein in the software routing step, the software routing process is executed on a received frame judged as not being an object of the hardware routing process in the step of determining the received frame.

15. The routing method according to claim 13, wherein in the validating step, the validating process, including a maximum frame length check, is executed on the transmission frame that has undergone the hardware routing process.

16. The routing method according to claim 15, wherein in the software routing step, when the validity of the transmission frame that has undergone the hardware routing process is denied in the validating step, the software routing process is executed on the corresponding received frame which is in a state before the execution of the hardware routing process.
